(19) United States
(12) Patent Application Publication
(10) Pub. No.: US 2026/0040323 A1
(43) Pub. Date: Feb. 5, 2026

(54) DEVICES, METHODS, APPARATUSES, AND COMPUTER READABLE MEDIA FOR FEEDBACK TRANSMISSION

(71) Applicant: Nokia Technologies Oy, Espoo (FI)

(72) Inventors: Pingping WEN, Shanghai (CN); Ping YUAN, Beijing (CN)

(73) Assignee: Nokia Technologies Oy, Espoo (FI)

(21) Appl. No.: 19/099,560

(22) PCT Filed: Aug. 3, 2022
(86) PCT No.: PCT/CN2022/109927

§ 371 Date: Jan. 29, 2025

(51) Int. Cl. H04W 72/231; H04L 5/00

(52) U.S. Cl. CPC H04W 72/231; H04L 5/0055

(57) ABSTRACT

Disclosed are devices, methods, apparatuses, and computer readable media for feedback transmission. An example terminal device may include at least one processor and at least one memory. The at least one memory may store instructions that, when executed by the at least one processor, may cause the terminal device at least to perform: receiving from a network device, a downlink medium access control control element on a hybrid automatic repeat request process configured or indicated with hybrid automatic repeat request feedback disabled; and transmitting to the network device, a feedback for the downlink medium access control control element.

### TECHNICAL FIELD

Various example embodiments relate to devices, methods, apparatuses, and computer readable media for feedback transmission.

BACKGROUND

For internet of things (IoT) over a non-terrestrial network (NTN), such as narrowband IoT (NB-IoT), enhanced machine type communication (eMTC) over the NTN, etc., disabling hybrid automatic repeat request (HARQ) feedback may bring about at least the following advantages: user equipment (UE) power consumption and latency can be reduced; HARQ stalling for NB-IoT due to large round trip time (RTT) in the NTN can be mitigated; uplink throughput in the NTN can be improved as more resource could be available in uplink; etc. On the other hand, if the HARQ feedback is disabled, layer 1 (L1) reliability of the downlink transmission may degrade due to the lack of HARQ feedback. In addition, disabling HARQ feedback for some important physical downlink shared channel (PDSCH) as well as medium access control control element (MAC CE) will impact the system operation. For example, for the case that single HARQ process is configured, the MAC CE which relies on the HARQ feedback for activation cannot be activated if the MAC CE is transmitted on a HARQ process configured or indicated with HARQ feedback disabled.

### SUMMARY

A brief summary of exemplary embodiments is provided below to provide basic understanding of some aspects of various embodiments. It should be noted that this summary is not intended to identify key features of essential elements or define scopes of the embodiments, and its sole purpose is to introduce some concepts in a simplified form as a preamble for a more detailed description provided below.

In a first aspect, disclosed is a terminal device. The terminal device may include at least one processor and at least one memory. The at least one memory may store instructions that, when executed by the at least one processor, may cause the terminal device at least to perform: receiving from a network device, a downlink medium access control control element on a hybrid automatic repeat request process configured or indicated with hybrid automatic repeat request feedback disabled; and transmitting to the network device, a feedback for the downlink medium access control control element.

In some example embodiments, the feedback may be transmitted according to a format indicated by the network device.

In some example embodiments, the format may be a first format or a second format indicated in downlink control information from the network device.

In some example embodiments, the first format or the second format may be indicated in a hybrid automatic repeat request acknowledgement resource field in the downlink control information of format N1.

In some example embodiments, the format may be a first format or a second format, and the first format may be indicated by an absence of resources for the second format in downlink control information from the network device.

In some example embodiments, the first format may be narrowband physical uplink shared channel format1, and the second format may be narrowband physical uplink shared channel format2.

In some example embodiments, the feedback may be transmitted in an uplink medium access control control element or in a medium access control protocol data unit header.

In some example embodiments, the feedback may be transmitted in case of receiving from the network device, an indication indicating that the solution of the feedback for the downlink medium access control control element on the hybrid automatic repeat request process configured or indicated with hybrid automatic repeat request feedback disabled is supported.

In some example embodiments, the indication may be received via at least one of the following: a system information block or a radio resource control signaling.

In some example embodiments, in a case where more than one downlink medium access control control elements on the hybrid automatic repeat request process configured or indicated with hybrid automatic repeat request feedback disabled are received before transmitting the feedback, the feedback for the downlink medium access control control elements may be indicated in a bitmap transmitted to the network device.

In some example embodiments, in a case where more than one downlink medium access control control elements on the hybrid automatic repeat request process configured or indicated with hybrid automatic repeat request feedback disabled are received before transmitting the feedback, the feedback for the downlink medium access control control elements may be indicated in a feedback bundling transmitted to the network device.

In some example embodiments, the hybrid automatic repeat request process may be a single hybrid automatic repeat request process configured for the terminal device.

In a second aspect, disclosed is a network device. The network device may include at least one processor and at least one memory. The at least one memory may store instructions that, when executed by the at least one processor, may cause the network device at least to perform: transmitting to a terminal device, a downlink medium access control control element on a hybrid automatic repeat request process configured or indicated with hybrid automatic repeat request feedback disabled; and receiving from the terminal device, a feedback for the downlink medium access control control element.

In some example embodiments, the instructions, when executed by the at least one processor, may cause the network device to further perform: determining a format for the terminal device to transmit the feedback; and indicating the terminal device to transmit the feedback according to the determined format.

In some example embodiments, the format may be a first format or a second format indicated in downlink control information from the network device.

In some example embodiments, the first format or the second format may be indicated in a hybrid automatic repeat request acknowledgement resource field in the downlink control information of format N1.

In some example embodiments, the format may be a first format or a second format, and the first format may be indicated by an absence of resources for the second format in downlink control information from the network device.

In some example embodiments, the first format may be determined in a case where there is at least one of the following in the terminal device to be transmitted: uplink data or an uplink medium access control control element.

In some example embodiments, the first format may be narrowband physical uplink shared channel format1, and the second format may be narrowband physical uplink shared channel format2.

In some example embodiments, the instructions, when executed by the at least one processor, may cause the network device to further perform: transmitting to the terminal device, an indication indicating that the solution of the feedback for the downlink medium access control control element on the hybrid automatic repeat request process configured or indicated with hybrid automatic repeat request feedback disabled is supported.

In some example embodiments, the indication may be transmitted via at least one of the following: a system information block or a radio resource control signaling.

In some example embodiments, the hybrid automatic repeat request process may be a single hybrid automatic repeat request process configured for the terminal device.

In a third aspect, disclosed is a method performed by a terminal device. The method may comprise: receiving from a network device, a downlink medium access control control element on a hybrid automatic repeat request process configured or indicated with hybrid automatic repeat request feedback disabled; and transmitting to the network device, a feedback for the downlink medium access control control element.

In some example embodiments, the feedback may be transmitted according to a format indicated by the network device.

In some example embodiments, the format may be a first format or a second format indicated in downlink control information from the network device.

In some example embodiments, the first format or the second format may be indicated in a hybrid automatic repeat request acknowledgement resource field in the downlink control information of format N1.

In some example embodiments, the format may be a first format or a second format, and the first format may be indicated by an absence of resources for the second format in downlink control information from the network device.

In some example embodiments, the first format may be narrowband physical uplink shared channel format1, and the second format may be narrowband physical uplink shared channel format2.

In some example embodiments, the feedback may be transmitted in an uplink medium access control control element or in a medium access control protocol data unit header.

In some example embodiments, the feedback may be transmitted in case of receiving from the network device, an indication indicating that the solution of the feedback for the downlink medium access control control element on the hybrid automatic repeat request process configured or indicated with hybrid automatic repeat request feedback disabled is supported.

In some example embodiments, the indication may be received via at least one of the following: a system information block or a radio resource control signaling.

In some example embodiments, in a case where more than one downlink medium access control control elements on the hybrid automatic repeat request process configured or indicated with hybrid automatic repeat request feedback disabled are received before transmitting the feedback, the feedback for the downlink medium access control control elements may be indicated in a bitmap transmitted to the network device.

In some example embodiments, in a case where more than one downlink medium access control control elements on the hybrid automatic repeat request process configured or indicated with hybrid automatic repeat request feedback disabled are received before transmitting the feedback, the feedback for the downlink medium access control control elements may be indicated in a feedback bundling transmitted to the network device.

In some example embodiments, the hybrid automatic repeat request process may be a single hybrid automatic repeat request process configured for the terminal device.

In a fourth aspect, disclosed is a method performed by a network device. The method may comprise: transmitting to a terminal device, a downlink medium access control control element on a hybrid automatic repeat request process configured or indicated with hybrid automatic repeat request feedback disabled; and receiving from the terminal device, a feedback for the downlink medium access control control element.

In some example embodiments, the method may further comprise: determining a format for the terminal device to transmit the feedback; and indicating the terminal device to transmit the feedback according to the determined format.

In some example embodiments, the format may be a first format or a second format indicated in downlink control information from the network device.

In some example embodiments, the first format or the second format may be indicated in a hybrid automatic repeat request acknowledgement resource field in the downlink control information of format N1.

In some example embodiments, the format may be a first format or a second format, and the first format may be indicated by an absence of resources for the second format in downlink control information from the network device.

In some example embodiments, the first format may be determined in a case where there is at least one of the following in the terminal device to be transmitted: uplink data or an uplink medium access control control element.

In some example embodiments, the first format may be narrowband physical uplink shared channel format1, and the second format may be narrowband physical uplink shared channel format2.

In some example embodiments, the method may further comprise: transmitting to the terminal device, an indication indicating that the solution of the feedback for the downlink medium access control control element on the hybrid automatic repeat request process configured or indicated with hybrid automatic repeat request feedback disabled is supported.

In some example embodiments, the indication may be transmitted via at least one of the following: a system information block or a radio resource control signaling.

In some example embodiments, the hybrid automatic repeat request process may be a single hybrid automatic repeat request process configured for the terminal device.

In a fifth aspect, disclosed is an apparatus. The apparatus as a terminal device may comprise: means for receiving from a network device, a downlink medium access control control element on a hybrid automatic repeat request process configured or indicated with hybrid automatic repeat request feedback disabled; and means for transmitting to the network device, a feedback for the downlink medium access control control element.

In some example embodiments, the feedback may be transmitted according to a format indicated by the network device.

In some example embodiments, the format may be a first format or a second format indicated in downlink control information from the network device.

In some example embodiments, the first format or the second format may be indicated in a hybrid automatic repeat request acknowledgement resource field in the downlink control information of format N1.

In some example embodiments, the format may be a first format or a second format, and the first format may be indicated by an absence of resources for the second format in downlink control information from the network device.

In some example embodiments, the first format may be narrowband physical uplink shared channel format1, and the second format may be narrowband physical uplink shared channel format2.

In some example embodiments, the feedback may be transmitted in an uplink medium access control control element or in a medium access control protocol data unit header.

In some example embodiments, the feedback may be transmitted in case of receiving from the network device, an indication indicating that the solution of the feedback for the downlink medium access control control element on the hybrid automatic repeat request process configured or indicated with hybrid automatic repeat request feedback disabled is supported.

In some example embodiments, the indication may be received via at least one of the following: a system information block or a radio resource control signaling.

In some example embodiments, in a case where more than one downlink medium access control control elements on the hybrid automatic repeat request process configured or indicated with hybrid automatic repeat request feedback disabled are received before transmitting the feedback, the feedback for the downlink medium access control control elements may be indicated in a bitmap transmitted to the network device.

In some example embodiments, in a case where more than one downlink medium access control control elements on the hybrid automatic repeat request process configured or indicated with hybrid automatic repeat request feedback disabled are received before transmitting the feedback, the feedback for the downlink medium access control control elements may be indicated in a feedback bundling transmitted to the network device.

In some example embodiments, the hybrid automatic repeat request process may be a single hybrid automatic repeat request process configured for the terminal device.

In a sixth aspect, disclosed is an apparatus. The apparatus as a network device may comprise: means for transmitting to a terminal device, a downlink medium access control control element on a hybrid automatic repeat request process configured or indicated with hybrid automatic repeat request feedback disabled; and means for receiving from the terminal device, a feedback for the downlink medium access control control element.

In some example embodiments, the apparatus may further comprise: means for determining a format for the terminal device to transmit the feedback; and means for indicating the terminal device to transmit the feedback according to the determined format.

In some example embodiments, the format may be a first format or a second format indicated in downlink control information from the network device.

In some example embodiments, the first format or the second format may be indicated in a hybrid automatic repeat request acknowledgement resource field in the downlink control information of format N1.

In some example embodiments, the format may be a first format or a second format, and the first format may be indicated by an absence of resources for the second format in downlink control information from the network device.

In some example embodiments, the first format may be determined in a case where there is at least one of the following in the terminal device to be transmitted: uplink data or an uplink medium access control control element.

In some example embodiments, the first format may be narrowband physical uplink shared channel format1, and the second format may be narrowband physical uplink shared channel format2.

In some example embodiments, the apparatus may further comprise: means for transmitting to the terminal device, an indication indicating that the solution of the feedback for the downlink medium access control control element on the hybrid automatic repeat request process configured or indicated with hybrid automatic repeat request feedback disabled is supported.

In some example embodiments, the indication may be transmitted via at least one of the following: a system information block or a radio resource control signaling.

In some example embodiments, the hybrid automatic repeat request process may be a single hybrid automatic repeat request process configured for the terminal device.

In a seventh aspect, a computer readable medium is disclosed. The computer readable medium may comprise program instructions that, when executed by a terminal device, may cause the terminal device at least to perform: receiving from a network device, a downlink medium access control control element on a hybrid automatic repeat request process configured or indicated with hybrid automatic repeat request feedback disabled; and transmitting to the network device, a feedback for the downlink medium access control control element.

In some example embodiments, the feedback may be transmitted according to a format indicated by the network device.

In some example embodiments, the format may be a first format or a second format indicated in downlink control information from the network device.

In some example embodiments, the first format or the second format may be indicated in a hybrid automatic repeat request acknowledgement resource field in the downlink control information of format N1.

In some example embodiments, the format may be a first format or a second format, and the first format may be indicated by an absence of resources for the second format in downlink control information from the network device.

In some example embodiments, the first format may be narrowband physical uplink shared channel format1, and the second format may be narrowband physical uplink shared channel format2.

In some example embodiments, the feedback may be transmitted in an uplink medium access control control element or in a medium access control protocol data unit header.

In some example embodiments, the feedback may be transmitted in case of receiving from the network device, an indication indicating that the solution of the feedback for the downlink medium access control control element on the hybrid automatic repeat request process configured or indicated with hybrid automatic repeat request feedback disabled is supported.

In some example embodiments, the indication may be received via at least one of the following: a system information block or a radio resource control signaling.

In some example embodiments, in a case where more than one downlink medium access control control elements on the hybrid automatic repeat request process configured or indicated with hybrid automatic repeat request feedback disabled are received before transmitting the feedback, the feedback for the downlink medium access control control elements may be indicated in a bitmap transmitted to the network device.

In some example embodiments, in a case where more than one downlink medium access control control elements on the hybrid automatic repeat request process configured or indicated with hybrid automatic repeat request feedback disabled are received before transmitting the feedback, the feedback for the downlink medium access control control elements may be indicated in a feedback bundling transmitted to the network device.

In some example embodiments, the hybrid automatic repeat request process may be a single hybrid automatic repeat request process configured for the terminal device.

In an eighth aspect, a computer readable medium is disclosed. The computer readable medium may comprise program instructions that, when executed by a network device, cause the network device at least to perform: transmitting to a terminal device, a downlink medium access control control element on a hybrid automatic repeat request process configured or indicated with hybrid automatic repeat request feedback disabled; and receiving from the terminal device, a feedback for the downlink medium access control control element.

In some example embodiments, the computer readable medium may further comprise instructions that, when executed by the network device, may cause the network device to further perform: determining a format for the terminal device to transmit the feedback; and indicating the terminal device to transmit the feedback according to the determined format.

In some example embodiments, the format may be a first format or a second format indicated in downlink control information from the network device.

In some example embodiments, the first format or the second format may be indicated in a hybrid automatic repeat request acknowledgement resource field in the downlink control information of format N1.

In some example embodiments, the format may be a first format or a second format, and the first format may be indicated by an absence of resources for the second format in downlink control information from the network device.

In some example embodiments, the first format may be determined in a case where there is at least one of the following in the terminal device to be transmitted: uplink data or an uplink medium access control control element.

In some example embodiments, the first format may be narrowband physical uplink shared channel format1, and the second format may be narrowband physical uplink shared channel format2.

In some example embodiments, the computer readable medium may further comprise instructions that, when executed by the network device, may cause the network device to further perform: transmitting to the terminal device, an indication indicating that the solution of the feedback for the downlink medium access control control element on the hybrid automatic repeat request process configured or indicated with hybrid automatic repeat request feedback disabled is supported.

In some example embodiments, the indication may be transmitted via at least one of the following: a system information block or a radio resource control signaling.

In some example embodiments, the hybrid automatic repeat request process may be a single hybrid automatic repeat request process configured for the terminal device.

Other features and advantages of the example embodiments of the present disclosure will also be apparent from the following description of specific embodiments when read in conjunction with the accompanying drawings, which illustrate, by way of example, the principles of example embodiments of the present disclosure.

### BRIEF DESCRIPTION OF THE DRAWINGS

Some example embodiments will now be described, by way of non-limiting examples, with reference to the accompanying drawings.

FIG. 1 shows an exemplary sequence diagram for feedback transmission according to the example embodiments of the present disclosure.

FIG. 2 shows an exemplary flow for feedback transmission according to the example embodiments of the present disclosure.

FIG. 3 shows a flow chart illustrating an example method 300 for feedback transmission according to the example embodiments of the present disclosure.

FIG. 4 shows a flow chart illustrating an example method 400 for feedback transmission according to the example embodiments of the present disclosure.

FIG. 5 shows a block diagram illustrating an example device 500 for feedback transmission according to the example embodiments of the present disclosure.

FIG. 6 shows a block diagram illustrating an example device 600 for feedback transmission according to the example embodiments of the present disclosure.

FIG. 7 shows a block diagram illustrating an example apparatus 700 for feedback transmission according to the example embodiments of the present disclosure.

FIG. 8 shows a block diagram illustrating an example apparatus 800 for feedback transmission according to the example embodiments of the present disclosure.

Throughout the drawings, same or similar reference numbers indicate same or similar elements. A repetitive description on the same elements would be omitted.

### DETAILED DESCRIPTION

Herein below, some example embodiments are described in detail with reference to the accompanying drawings. The following description includes specific details for the purpose of providing a thorough understanding of various concepts. However, it will be apparent to those skilled in the art that these concepts may be practiced without these specific details. In some instances, well known circuits, techniques and components are shown in block diagram form to avoid obscuring the described concepts and features.

Example embodiments of the present disclosure provide a solution for feedback transmission. According to the example embodiments of the present disclosure, if a downlink MAC CE is transmitted on a HARQ process configured or indicated with HARQ feedback disabled, a feedback for the downlink MAC CE may be transmitted. Thus, disabling HARQ feedback can be supported and the advantages described above brought about by disabling HARQ feedback may be obtained such that the performance can be improved. Furthermore, disabling HARQ feedback will not bring the impact on some “important” system operation. Example embodiments of the present disclosure may apply in the IoT over the NTN.

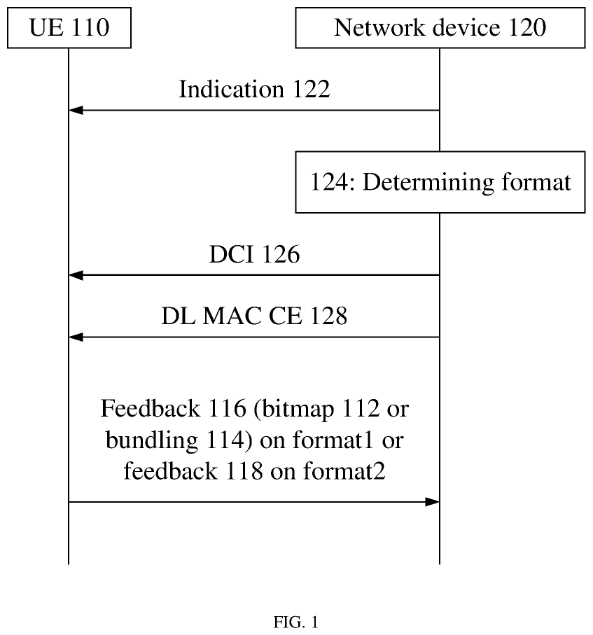

FIG. 1 shows an exemplary sequence diagram for feedback transmission according to the example embodiments of the present disclosure. Referring to the FIG. 1, a UE 110 may represent any terminal device in an IoT over a NTN. A network device 120 may function as a base station (BS) in the NTN and be associated with a cell serving the UE 110.

Referring to the FIG. 1, the network device 120 may transmit to the UE 110, a downlink MAC CE 128 on a HARQ process configured or indicated with HARQ feedback disabled. The downlink MAC CE may be carried on a PDSCH. In case of NB-IoT, the downlink MAC CE may be carried on a narrowband PDSCH (NPDSCH). Although the downlink MAC CE 128 is transmitted on the HARQ process configured or indicated with HARQ feedback disabled, receiving the downlink MAC CE 128, the UE 110 may transmit to the network device 120, a feedback 116 or a feedback 118 for the downlink MAC CE 128. The feedback 116 or the feedback 118 may be an acknowledgement (ACK) feedback or a non-acknowledgement (NACK) feedback for the downlink MAC CE 128.

In an embodiment, in an operation 124, the network device 120 may determine a format for the UE 110 to transmit the feedback 116 or the feedback 118, and then indicate the UE 110 to transmit the feedback 116 or 118 according to the determined format. The format may be a first format or a second format. The first format may be used for carrying the feedback and other uplink transmission such as uplink data, an uplink MAC CE, e.g. buffer status report (BSR), etc. The second format may be specifically used for carrying the feedback. The feedback 116 or 118 may be transmitted according to the format indicated by the network device 120.

In an embodiment, in a case where there is at least one of the following in the UE 110 to be transmitted: uplink data or an uplink MAC CE, in the operation 124, the network device 120 may determine the first format. For example, if the network device 120 is aware that the UE 110 will transmit uplink data or an uplink MAC CE on the first format soon after the network device 120 transmits the downlink MAC CE 128 to the UE 110, for example, the network device 120 will schedule from the UE 110 the uplink data or the uplink MAC CE on the first format soon after the transmission of the downlink MAC CE 128, the network device 120 may determine the first format and schedule the corresponding uplink resources. Thus, the UE 110 may transmit to the network device 120, the feedback 116 with the uplink data or the uplink MAC CE e.g. the BSR according to the first format.

Alternatively, in an embodiment, if the network device 120 is aware that the UE 110 will not transmit uplink data or an uplink MAC CE during a certain period after the network device 120 transmits the downlink MAC CE to the UE 110, the network device 120 may determine the second format and schedule the corresponding uplink resources. Thus, the UE 110 may transmit to the network device 120, the feedback 118 according to the second format.

In an embodiment, the network device 120 may transmit to the UE 110 downlink control information (DCI) 126 for indicating the UE 110 the determined format. For example, the first format or the second format may be indicated in the DCI 126. In an embodiment, the DCI 126 may be, e.g., of DCI format N1 described in 3rd Generation Partnership Project (3GPP) Specification 36.213, and the first format or the second format may be indicated in a field of HARQ-ACK resource in the DCI format N1. For example, two fields in the HARQ-ACK resource filed may be pre-defined or configured to indicate whether the first format or the second format is determined by the network device 120.

Alternatively, in an embodiment, the first format may be indicated by an absence of resources for the second format in the DCI 126. For example, if the DCI 126 shows that there is no resources scheduled for the second format, the first format may be implicitly indicted by the DCI 126. In this embodiment, the DCI 126 may also be of the DCI format N1. For example, the HARQ-ACK resource filed with a value of zero can be used to indicate no resources allocated for the second format, then the DCI 126 may implicitly indicate the first format.

In case of the NB-IoT, the first format may be NPDSCH format1 described in 3GPP Specification 36.213, and the second format may be NPDSCH format2 described in 3GPP Specification 36.213.

In an embodiment, as an option, the network device 120 may determine whether the solution of the feedback for the downlink MAC CE on the HARQ process configured or indicated with HARQ feedback disabled is supported for the UE 110 and then transmit to the UE 110 an indication 122 indicating whether the solution is supported.

In a case where the indication 122 indicates that the solution is not supported, receiving the indication 122, the UE 110 cannot transmit the feedback 116 or 118 if the downlink MAC CE 128 is transmitted on the HARQ process configured or indicated with HARQ feedback disabled.

In a case where the indication 122 indicates that the solution of the feedback for the downlink MAC CE on the HARQ process configured or indicated with HARQ feedback disabled is supported, receiving the indication 122, the UE 110 may transmit the feedback 116 or 118 for the downlink MAC CE.

In an embodiment, the solution of the feedback for the downlink MAC CE on the HARQ process configured or indicated with HARQ feedback disabled may be that the feedback for the downlink MAC CE on the HARQ process configured or indicated with HARQ feedback disabled will be transmitted according to the first format, e.g. the NPDSCH format1, or the second format, e.g. the NPDSCH format2. In this case, if the solution is supported, the feedback for the downlink MAC CE on the HARQ process configured or indicated with HARQ feedback disabled will be transmitted according to the first format or the second format.

In an embodiment, the solution of the feedback for the downlink MAC CE on the HARQ process configured or indicated with HARQ feedback disabled may be that in a case where there are uplink data and/or an uplink MAC CE in the UE 110 to be transmitted, the feedback for the downlink MAC CE on the HARQ process configured or indicated with HARQ feedback disabled will be transmitted according to the first format, e.g. the NPDSCH format1. In this case, if the solution is supported and there are uplink data and/or an uplink MAC CE in the UE 110 to be transmitted, the feedback for the downlink MAC CE on the HARQ process configured or indicated with HARQ feedback disabled will be transmitted according to the first format.

The indication 122 may be transmitted via at least one of the following: a system information block (SIB) or a radio resource control (RRC) signaling. For example, the indication 122 may be a semi-static flag.

In an embodiment, the feedback 116 may be transmitted in an uplink MAC CE or in a medium access control (MAC) protocol data unit (PDU) header. For example, the feedback 116 may be carried in a dedicated uplink MAC CE on the first format e.g. the NPUSCH format1. Alternatively, the feedback 116 may be piggybacked in a MAC PDU header on the first format e.g. the NPUSCH format1. For example, a reserved bit in the MAC PDU header may be used to carry the feedback 116.

In an embodiment, the UE 110 may receive from the network device 120 more than one downlink MAC CEs 128 on the HARQ process configured or indicated with HARQ feedback disabled before transmitting the feedback 116. For example, if the UE 110 is indicated to use the first format for the feedback 116 but the network device 120 has not scheduled the resources for the first format, the UE 110 may have received multiple NPDSCH carrying the MAC CEs 128 before transmitting the feedback 116. After being scheduled with the resources for the first format, the UE 110 is to transmit the feedback 116 for the more than one MAC CEs 128 in more than one NPDSCHs. In this case, the UE 110 may indicate the network device 120 the feedback 116 for the downlink MAC CEs 128. For example, the UE 110 may transmit to the network device 120, a bitmap 112 indicating the feedback 116 for the downlink MAC CEs 128. Alternatively, the UE 110 may transmit to the network device 120, a feedback bundling 114 indicating the feedback 116 for the downlink MAC CEs 128.

The feedback bundling 114 may be an acknowledgement bundling. In a case where the UE 110 may acknowledge the more than one downlink MAC CEs 128, i.e. ACKs for the downlink MAC CEs 128, the feedback bundling 114 may be a bundling ACK. Otherwise, the feedback bundling 114 may be a NACK. The bitmap 112 may indicate the corresponding relationship between different parts of the feedback 116 on the first format, e.g. the NPDSCH format1, and the downlink MAC CEs 128. In this case, the feedback 116 may be indicated in the bitmap 112 or the feedback bundling 114 transmitted to the network device 120.

In an embodiment, the HARQ process may be a single HARQ process configured for the UE 110. In this case, regardless whether the HARQ process is configured or indicated with HARQ feedback disabled or enabled, the downlink MAC CE may probably have to be transmitted on the single HARQ process. In the solution for feedback transmission according to of the example embodiments of the present disclosure, the UE 110 may transmit the feedback 116 or 118 for the downlink MAC CE 128 even if the downlink MAC CE 128 is received on the single HARQ process configured or indicated with HARQ feedback disabled.

In some embodiments, the NB-IoT over the NTN is taken as an example scenario the solution for feedback transmission according to the example embodiments of the present disclosure may apply. Because in the NB-IoT at most 2 HARQ processes are configured, it is more probable that the UE 110 is configured with the single HARQ process configured or indicated with HARQ feedback disabled. It may be appreciated that the solution for feedback transmission according to of the example embodiments of the present disclosure may also apply in other IoT such as the eMTC over the NTN, although in the eMTC more HARQ processes may be configured. For example, in the eMTC, if the UE 110 receives the downlink MAC CE 128 on the HARQ process configured or indicated with HARQ feedback disabled, the UE 110 may transmit the feedback 116 or 118 for the downlink MAC CE 128.

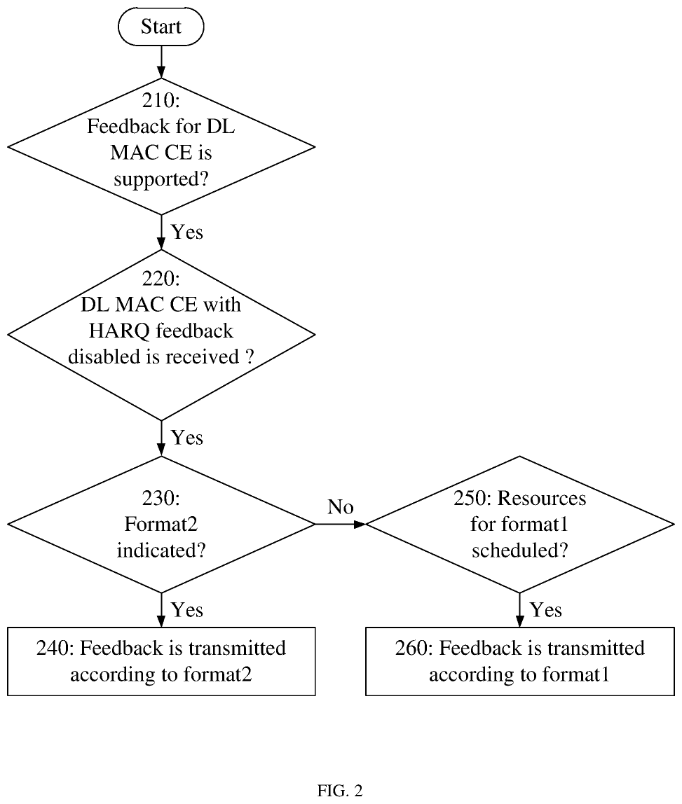

FIG. 2 shows an exemplary flow for feedback transmission according to the example embodiments of the present disclosure. In an embodiment, the UE 110 and the network device 120 may operate according to the exemplary flow. Details which have been described with respect to the FIG. 1 are briefly described or omitted.

Referring to the FIG. 2, after the start of the flow, in an operation 210, the network device 120 may determine whether the solution of the feedback for the downlink MAC CE on the HARQ process configured or indicated with HARQ feedback disabled is supported. If the solution is supported (“Yes” prong of the operation 210), the network device 120 may notify the UE 110, e.g. via the indication 122, that the solution of the feedback for the downlink MAC CE on the HARQ process configured or indicated with HARQ feedback disabled is supported.

In an operation 220, if the UE 110 receives the downlink MAC CE, e.g. carried in a NPDSCH, and the HARQ feedback is disabled (“Yes” prong of the operation 220), in an operation 230, the UE 110 may check whether the second format, e.g. the NPUSCH format2, is indicated by the network device 120. The format may be explicitly or implicated indicated by e.g. the DCI 126. For example, no resources scheduled for the second format may indicate the first format.

If the second format is indicated (“Yes” prong of the operation 230), in an operation 240, the UE 110 may transmit to the network device 120, the feedback e.g. the feedback 118 for the downlink MAC CE according to the second format.

If the second format is not indicated (“No” prong of the operation 230), in an operation 250, the UE 110 may check whether resources for the first format, e.g. the NPUSCH are scheduled. If the resources for the first format are scheduled (“Yes” prong of the operation 250), in an operation 260, the UE 110 may transmit to the network device 120, the feedback e.g. the feedback 116 for the downlink MAC CE, with uplink data and/or other uplink MAC CE(s) according to the first format, e.g. the NPUSCH format1.

In the solution for feedback transmission according to the example embodiments of the present disclosure, the network side may schedule the first format, e.g. the NPUSCH format1, or the second format, e.g. the NPUSCH format2, resources for the downlink MAC CE feedback even if the HARQ feedback is disabled for the corresponding PDSCH carrying the MAC CE. With this solution, the function that the MAC CE relies on the HARQ feedback for activation can be supported. Thus, disabling HARQ feedback will not bring the impact on the system operation.

In addition, the network side can determine the feedback for the downlink MAC CE is carried on the first format, e.g. the NPUSCH format1, or the second format, e.g. the NPUSCH format2, taking into account many factors such as the system performance, UE power consumption, etc. For example, if the network side knows the network side will schedule uplink data and/or other uplink MAC CE(s) on the first format, e.g. the NPUSCH format1, soon after the network side transmits the downlink MAC CE carried by e.g. the NPDSCH, the network side will not schedule the second format, e.g. the NPUSCH format2 for the downlink MAC CE feedback since the second format, e.g. the NPUSCH format2 will consume both the resources and the UE power, and the first format to be scheduled can carry the downlink MAC CE feedback. If the network side will not schedule e.g. uplink data on e.g. the NPUSCH format1 during a certain time period after the transmission of the downlink MAC CE, the network side may schedule the resources for e.g. the NPUSCH format2 together with the NPDSCH carrying the downlink MAC CE.

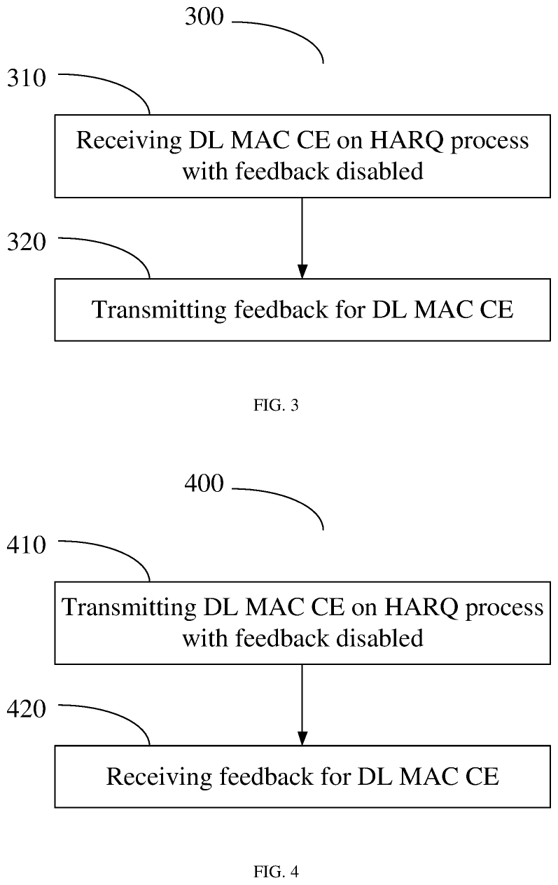

FIG. 3 shows a flow chart illustrating an example method 300 for feedback transmission according to the example embodiments of the present disclosure. The example method 300 may be performed for example by a terminal device such as the UE 110.

Referring to the FIG. 3, the example method 300 may include an operation 310 of receiving from a network device, a downlink MAC CE on a HARQ process configured or indicated with MAC CE feedback disabled; and an operation 320 of transmitting to the network device, a feedback for the downlink MAC CE.

Details of the operation 310 have been described in the above descriptions with respect to at least the downlink MAC CE 128 and the operation 220, and repetitive descriptions thereof are omitted here.

Details of the operation 320 have been described in the above descriptions with respect to at least the feedback 116, the feedback 118 and the operations 240 and 260, and repetitive descriptions thereof are omitted here.

In an embodiment, the feedback may be transmitted according to a format indicated by the network device. The more details have been described in the above descriptions with respect to at least the operation 124, and the operations 240 and 260, and repetitive descriptions thereof are omitted here.

In an embodiment, the format may be a first format or a second format indicated in DCI from the network device. The more details have been described in the above descriptions with respect to at least the DCI 126, and repetitive descriptions thereof are omitted here.

In an embodiment, the first format or the second format may be indicated in a HARQ-ACK resource field in the DCI of format N1. The more details have been described in the above descriptions with respect to at least the HARQ-ACK resource field and the DCI format N1, and repetitive descriptions thereof are omitted here.

In an embodiment, the format may be a first format or a second format, and the first format may be indicated by an absence of resources for the second format in DCI from the network device. The more details have been described in the above descriptions with respect to at least the DCI 126 and the HARQ-ACK resource field, and repetitive descriptions thereof are omitted here.

In an embodiment, the first format may be NPUSCH format1, and the second format is NPUSCH format2. The more details have been described in the above descriptions with respect to at least the NPUSCH format1 and the NPUSCH format2, and repetitive descriptions thereof are omitted here.

In an embodiment, the feedback may be transmitted in an uplink MAC CE or in a MAC PDU header. The more details have been described in the above descriptions with respect to at least the feedback 116, and repetitive descriptions thereof are omitted here.

In an embodiment, the feedback may be transmitted in case of receiving from the network device, an indication indicating that the solution of the feedback for the downlink MAC CE on the HARQ process configured or indicated with HARQ feedback disabled is supported. The more details have been described in the above descriptions with respect to at least the indication 122 and the operation 210, and repetitive descriptions thereof are omitted here.

In an embodiment, the indication may be received via at least one of the following: a SIB or a RRC signaling. The more details have been described in the above descriptions with respect to at least the indication 122, the SIB and the RRC signaling, and repetitive descriptions thereof are omitted here.

In an embodiment, in a case where more than one downlink MAC CEs on the HARQ process configured or indicated with HARQ feedback disabled are received before transmitting the feedback, the feedback for the downlink MAC CEs may be indicated in a bitmap transmitted to the network device. The more details have been described in the above descriptions with respect to at least the bitmap 112, and repetitive descriptions thereof are omitted here.

In an embodiment, in a case where more than one downlink MAC CEs on the HARQ process configured or indicated with HARQ feedback disabled are received before transmitting the feedback, the feedback for the downlink MAC CEs may be indicated in a feedback bundling transmitted to the network device. The more details have been described in the above descriptions with respect to at least the feedback bundling 114, and repetitive descriptions thereof are omitted here.

In an embodiment, the HARQ process may be a single HARQ process configured for the terminal device.

FIG. 4 shows a flow chart illustrating an example method 400 for feedback transmission according to the example embodiments of the present disclosure. The example method 400 may be performed for example by a network device such as the network device 120.

Referring to the FIG. 4, the example method 400 may include an operation 410 of transmitting to a terminal device, a downlink MAC CE on a HARQ process configured or indicated with HARQ feedback disabled; and an operation 420 of receiving from the terminal device, a feedback for the MAC CE.

Details of the operation 410 have been described in the above descriptions with respect to at least the downlink MAC CE 128 and the operation 220, and repetitive descriptions thereof are omitted here.

Details of the operation 420 have been described in the above descriptions with respect to at least the feedback 116, the feedback 118 and the operations 240 and 260, and repetitive descriptions thereof are omitted here.

In an embodiment, the example method 400 may further include an operation of determining a format for the terminal device to transmit the feedback; and an operation of indicating the terminal device to transmit the feedback according to the determined format. The more details have been described in the above descriptions with respect to at least the operation 124, and the operations 240 and 260, and repetitive descriptions thereof are omitted here.

In an embodiment, the format may be a first format or a second format indicated in DCI from the network device. The more details have been described in the above descriptions with respect to at least the DCI 126, and repetitive descriptions thereof are omitted here.

In an embodiment, the first format or the second format may be indicated in a HARQ-ACK resource field in the DCI of format N1. The more details have been described in the above descriptions with respect to at least the HARQ-ACK resource field and the DCI format N1, and repetitive descriptions thereof are omitted here.

In an embodiment, the format may be a first format or a second format, and the first format may be indicated by an absence of resources for the second format in DCI from the network device. The more details have been described in the above descriptions with respect to at least the DCI 126 and the HARQ-ACK resource field, and repetitive descriptions thereof are omitted here.

In an embodiment, the first format may be determined in a case where there is at least one of the following in the terminal device to be transmitted: uplink data or an uplink MAC CE. The more details have been described in the above descriptions with respect to at least the operation 124, and repetitive descriptions thereof are omitted here.

In an embodiment, the first format may be NPUSCH format1, and the second format may be NPUSCH format2. The more details have been described in the above descriptions with respect to at least the NPUSCH format1 and the NPUSCH format2, and repetitive descriptions thereof are omitted here.

In an embodiment, the example method 400 may further include an operation of transmitting to the terminal device, an indication indicating that the solution of the feedback for the downlink MAC CE on the HARQ process configured or indicated with HARQ feedback disabled is supported. The more details have been described in the above descriptions with respect to at least the indication 122 and the operation 210, and repetitive descriptions thereof are omitted here.

In an embodiment, the indication may be transmitted via at least one of the following: a SIB or a RRC signaling. The more details have been described in the above descriptions with respect to at least the indication 122, the SIB and the RRC signaling, and repetitive descriptions thereof are omitted here.

In an embodiment, the HARQ process may be a single HARQ process configured for the terminal device.

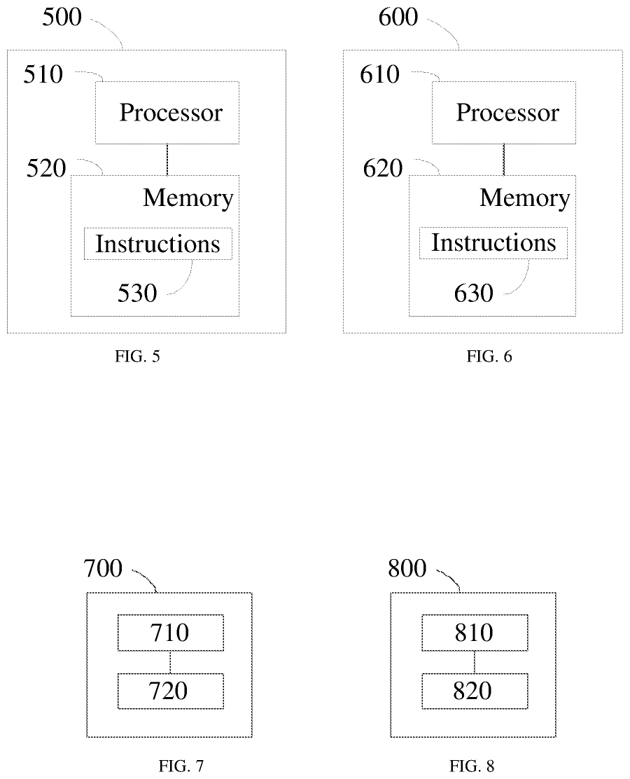

FIG. 5 shows a block diagram illustrating an example device 500 for feedback transmission according to the example embodiments of the present disclosure. The device, for example, may be at least part of a terminal device such as the UE 110 in the above examples.

As shown in the FIG. 5, the example device 500 may include at least one processor 510 and at least one memory 520 that may store instructions 530. The instructions 530, when executed by the at least one processor 510, may cause the device 500 at least to perform the example method 300 described above.

In various example embodiments, the at least one processor 510 in the example device 500 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 510 may also include at least one other circuitry or element not shown in the FIG. 5.

In various example embodiments, the at least one memory 520 in the example device 500 may include at least one storage medium in various forms, such as a transitory memory and/or a non-transitory memory. The transitory memory may include, but not limited to, for example, a random-access memory (RAM), a cache, and so on. The non-transitory memory may include, but not limited to, for example, a read only memory (ROM), a hard disk, a flash memory, and so on. The term “non-transitory,” as used herein, is a limitation of the medium itself (i.e., tangible, not a signal) as opposed to a limitation on data storage persistency (e.g., RAM vs. ROM). Further, the at least memory 520 may include, but are not limited to, an electric, a magnetic, an optical, an electromagnetic, an infrared, or a semiconductor system, apparatus, or device or any combination of the above.

Further, in various example embodiments, the example device 500 may also include at least one other circuitry, element, and interface, for example at least one I/O interface, at least one antenna element, and the like.

In various example embodiments, the circuitries, parts, elements, and interfaces in the example device 500, including the at least one processor 510 and the at least one memory 520, may be coupled together via any suitable connections including, but not limited to, buses, crossbars, wiring and/or wireless lines, in any suitable ways, for example electrically, magnetically, optically, electromagnetically, and the like.

It is appreciated that the structure of the device on the side of the UE 110 is not limited to the above example device 500.

FIG. 6 shows a block diagram illustrating an example device 600 for feedback transmission according to the example embodiments of the present disclosure. The device, for example, may be at least part of a network device such as the network device 120 in the above examples.

As shown in the FIG. 6, the example device 600 may include at least one processor 610 and at least one memory 620 that may store instructions 630. The instructions 630, when executed by the at least one processor 610, may cause the device 600 at least to perform the example method 400 described above.

In various example embodiments, the at least one processor 610 in the example device 600 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 610 may also include at least one other circuitry or element not shown in the FIG. 6.

In various example embodiments, the at least one memory 620 in the example device 600 may include at least one storage medium in various forms, such as a transitory memory and/or a non-transitory memory. The transitory memory may include, but not limited to, for example, a random-access memory (RAM), a cache, and so on. The non-transitory memory may include, but not limited to, for example, a read only memory (ROM), a hard disk, a flash memory, and so on. The term “non-transitory,” as used herein, is a limitation of the medium itself (i.e., tangible, not a signal) as opposed to a limitation on data storage persistency (e.g., RAM vs. ROM). Further, the at least memory 620 may include, but are not limited to, an electric, a magnetic, an optical, an electromagnetic, an infrared, or a semiconductor system, apparatus, or device or any combination of the above.

Further, in various example embodiments, the example device 600 may also include at least one other circuitry, element, and interface, for example at least one I/O interface, at least one antenna element, and the like.

In various example embodiments, the circuitries, parts, elements, and interfaces in the example device 600, including the at least one processor 610 and the at least one memory 620, may be coupled together via any suitable connections including, but not limited to, buses, crossbars, wiring and/or wireless lines, in any suitable ways, for example electrically, magnetically, optically, electromagnetically, and the like.

It is appreciated that the structure of the device on the side of the network device 120 is not limited to the above example device 600.

FIG. 7 shows a block diagram illustrating an example apparatus 700 for feedback transmission according to the example embodiments of the present disclosure. The apparatus, for example, may be at least part of a terminal device such as the UE 110 in the above examples.

As shown in FIG. 7, the example apparatus 700 may include means 710 for performing the operation 310 of the example method 300, and means 720 for performing the operation 320 of the example method 300. In one or more another example embodiments, at least one I/O interface, at least one antenna element, and the like may also be included in the example apparatus 700.

In an embodiment, the feedback may be transmitted according to a format indicated by the network device.

In an embodiment, the format may be a first format or a second format indicated in DCI from the network device.

In an embodiment, the first format or the second format may be indicated in a HARQ-ACK resource field in the DCI of format N1.

In an embodiment, the format may be a first format or a second format, and the first format may be indicated by an absence of resources for the second format in DCI from the network device.

In an embodiment, the first format may be NPUSCH format1, and the second format is NPUSCH format2.

In an embodiment, the feedback may be transmitted in an uplink MAC CE or in a MAC PDU header.

In an embodiment, the feedback may be transmitted in case of receiving from the network device, an indication indicating that the solution of the feedback for the downlink MAC CE on the HARQ process configured or indicated with HARQ feedback disabled is supported.

In an embodiment, the indication may be received via at least one of the following: a SIB or a RRC signaling.

In an embodiment, in a case where more than one downlink MAC CEs on the HARQ process configured or indicated with HARQ feedback disabled are received before transmitting the feedback, the feedback for the downlink MAC CEs may be indicated in a bitmap transmitted to the network device.

In an embodiment, in a case where more than one downlink MAC CEs on the HARQ process configured or indicated with HARQ feedback disabled are received before transmitting the feedback, the feedback for the downlink MAC CEs may be indicated in a feedback bundling transmitted to the network device.

In an embodiment, the HARQ process may be a single HARQ process configured for the terminal device.

In some example embodiments, examples of means in the example apparatus 700 may include circuitries. For example, an example of means 710 may include a circuitry configured to perform the operation 310 of the example method 300, and an example of means 720 may include a circuitry configured to perform the operation 320 of the example method 300.

The example apparatus 700 may further include means comprising circuitry configured to perform the example method 300. In some example embodiments, examples of means may also include software modules and any other suitable function entities.

FIG. 8 shows a block diagram illustrating an example apparatus 800 for feedback transmission according to the example embodiments of the present disclosure. The apparatus. for example, may be at least part of a network device such as the network device 120 in the above examples.

As shown in FIG. 8, the example apparatus 800 may include means 810 for performing the operation 410 of the example method 400, and means 820 for performing the operation 420 of the example method 400. In one or more another example embodiments, at least one I/O interface, at least one antenna element, and the like may also be included in the example apparatus 800.

In an embodiment, the example apparatus 800 may further include means for determining a format for the terminal device to transmit the feedback; and means for indicating the terminal device to transmit the feedback according to the determined format.

In an embodiment, the format may be a first format or a second format indicated in DCI from the network device.

In an embodiment, the first format or the second format may be indicated in a HARQ-ACK resource field in the DCI of format N1.

In an embodiment, the format may be a first format or a second format, and the first format may be indicated by an absence of resources for the second format in DCI from the network device.

In an embodiment, the first format may be determined in a case where there is at least one of the following in the terminal device to be transmitted: uplink data or an uplink MAC CE.

In an embodiment, the first format may be NPUSCH format1, and the second format may be NPUSCH format2.

In an embodiment, the example apparatus 800 may further include means for transmitting to the terminal device, an indication indicating that the solution of the feedback for the downlink MAC CE on the HARQ process configured or indicated with HARQ feedback disabled is supported.

In an embodiment, the indication may be transmitted via at least one of the following: a SIB or a RRC signaling.

In an embodiment, the HARQ process may be a single HARQ process configured for the terminal device.

In some example embodiments, examples of means in the example apparatus 800 may include circuitries. For example, an example of means 810 may include a circuitry configured to perform the operation 410 of the example method 400, and an example of means 820 may include a circuitry configured to perform the operation 420 of the example method 400.

The example apparatus 800 may further include means comprising circuitry configured to perform the example method 400. In some example embodiments, examples of means may also include software modules and any other suitable function entities.

The example embodiments of the present disclosure also provide a computer readable medium comprising program instructions that, when executed by a terminal device such as the UE 110 in the above examples, may cause the terminal device at least to perform: receiving from a network device, a downlink MAC CE on a HARQ process configured or indicated with MAC CE feedback disabled; and transmitting to the network device, a feedback for the downlink MAC CE.

In an embodiment, the feedback may be transmitted according to a format indicated by the network device.

In an embodiment, the format may be a first format or a second format indicated in DCI from the network device.

In an embodiment, the first format or the second format may be indicated in a HARQ-ACK resource field in the DCI of format N1.

In an embodiment, the format may be a first format or a second format, and the first format may be indicated by an absence of resources for the second format in DCI from the network device.

In an embodiment, the first format may be NPUSCH format1, and the second format is NPUSCH format2.

In an embodiment, the feedback may be transmitted in an uplink MAC CE or in a MAC PDU header.

In an embodiment, the feedback may be transmitted in case of receiving from the network device, an indication indicating that the solution of the feedback for the downlink MAC CE on the HARQ process configured or indicated with HARQ feedback disabled is supported.

In an embodiment, the indication may be received via at least one of the following: a SIB or a RRC signaling.

In an embodiment, in a case where more than one downlink MAC CEs on the HARQ process configured or indicated with HARQ feedback disabled are received before transmitting the feedback, the feedback for the downlink MAC CEs may be indicated in a bitmap transmitted to the network device.

In an embodiment, in a case where more than one downlink MAC CEs on the HARQ process configured or indicated with HARQ feedback disabled are received before transmitting the feedback, the feedback for the downlink MAC CEs may be indicated in a feedback bundling transmitted to the network device.

In an embodiment, the HARQ process may be a single HARQ process configured for the terminal device.

The example embodiments of the present disclosure also provide a computer readable medium comprising program instructions that, when executed by a network device such as the network device 120 in the above examples, may cause the network device at least to perform: transmitting to a terminal device, a downlink MAC CE on a HARQ process configured or indicated with HARQ feedback disabled; and receiving from the terminal device, a feedback for the MAC CE.

In an embodiment, the computer readable medium may further include instructions that, when executed by the network device, may cause the network device to further perform: determining a format for the terminal device to transmit the feedback; and indicating the terminal device to transmit the feedback according to the determined format.

In an embodiment, the format may be a first format or a second format indicated in DCI from the network device.

In an embodiment, the first format or the second format may be indicated in a HARQ-ACK resource field in the DCI of format N1.

In an embodiment, the format may be a first format or a second format, and the first format may be indicated by an absence of resources for the second format in DCI from the network device.

In an embodiment, the first format may be determined in a case where there is at least one of the following in the terminal device to be transmitted: uplink data or an uplink MAC CE.

In an embodiment, the first format may be NPUSCH format1, and the second format may be NPUSCH format2.

In an embodiment, the computer readable medium may further include instructions that, when executed by the network device, may cause the network device to further perform: transmitting to the terminal device, an indication indicating that the solution of the feedback for the downlink MAC CE on the HARQ process configured or indicated with HARQ feedback disabled is supported.

In an embodiment, the indication may be transmitted via at least one of the following: a SIB or a RRC signaling.

In an embodiment, the HARQ process may be a single HARQ process configured for the terminal device.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

The term “circuitry” throughout this disclosure may refer to one or more or all of the following: (a) hardware-only circuit implementations (such as implementations in only analog and/or digital circuitry); (b) combinations of hardware circuits and software, such as (as applicable) (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions); and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to one or all uses of this term in this disclosure, including in any claims. As a further example, as used in this disclosure, the term circuitry also covers an implementation of merely a hardware circuit or processor (or multiple processors) or portion of a hardware circuit or processor and its (or their) accompanying software and/or firmware. The term circuitry also covers, for example and if applicable to the claim element, a baseband integrated circuit or processor integrated circuit for a mobile device or a similar integrated circuit in server, a cellular network device, or other computing or network device.

Another example embodiment may relate to computer program codes or instructions which may cause an apparatus to perform at least respective methods described above. Another example embodiment may be related to a computer readable medium having such computer program codes or instructions stored thereon. In some embodiments, such a computer readable medium may include at least one storage medium in various forms such as a volatile memory and/or a non-volatile memory. The volatile memory may include, but not limited to, for example, a RAM, a cache, and so on. The non-volatile memory may include, but not limited to, a ROM, a hard disk, a flash memory, and so on. The non-volatile memory may also include, but are not limited to, an electric, a magnetic, an optical, an electromagnetic, an infrared, or a semiconductor system, apparatus, or device or any combination of the above.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

As used herein, the term “determine/determining” (and grammatical variants thereof) can include, not least: calculating, computing, processing, deriving, measuring, investigating, looking up (for example, looking up in a table, a database or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

While some embodiments have been described, these embodiments have been presented by way of example, and are not intended to limit the scope of the disclosure. Indeed, the apparatus, methods, and systems described herein may be embodied in a variety of other forms; furthermore, various omissions, substitutions and changes in the form of the methods and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. At least one of these blocks may be implemented in a variety of different ways. The order of these blocks may also be changed. Any suitable combination of the elements and actions of the some embodiments described above can be combined to provide further embodiments. The accompanying claims and their equivalents are intended to cover such forms or modifications as would fall within the scope and spirit of the disclosure.

Abbreviations used in the description and/or in the figures are defined as follows:

| | |
|---|---|
| 3GPP | 3rd Generation Partnership Project |
| ACK | acknowledgement |
| BS | base station |
| BSR | buffer status report |
| DCI | downlink control information |
| DL | downlink |
| eMTC | enhanced machine type communication |
| HARQ | hybrid automatic repeat request |
| ID | identifier |
| IoT | internet of things |
| L1 | layer 1 |
| MAC | medium access control |
| MAC CE | medium access control control element |
| NACK | non-acknowledgement |
| NB-IoT | narrow band internet of things |
| NPDSCH | narrowband physical downlink shared channel |
| NTN | non-terrestrial network |
| PDSCH | physical downlink shared channel |
| PDU | protocol data unit |
| RA | random access |
| RRC | radio resource control |
| RTT | round trip time |
| SIB | system information block |
| UE | user equipment |
| UL | uplink |

1. A terminal device, comprising:
at least one processor; and
at least one memory storing instructions that, when executed by the at least one processor, cause the terminal device at least to perform:
receiving from a network device, a downlink medium access control control element on a hybrid automatic repeat request process configured or indicated with hybrid automatic repeat request feedback disabled; and
transmitting to the network device, a feedback for the downlink medium access control control element.

2. The terminal device of claim 1, wherein the feedback is transmitted according to a format indicated by the network device.

3. The terminal device of claim 2, wherein the format is a first format or a second format indicated in downlink control information from the network device.

4. The terminal device of claim 3, wherein the first format or the second format is indicated in a hybrid automatic repeat request acknowledgement resource field in the downlink control information of format N1.

5. The terminal device of claim 2, wherein the format is a first format or a second format, and the first format is indicated by an absence of resources for the second format in downlink control information from the network device.

6. The terminal device of claim 3, wherein the first format is narrowband physical uplink shared channel format1, and the second format is narrowband physical uplink shared channel format2.

7. The terminal device of claim 1, wherein the feedback is transmitted in an uplink medium access control control element or in a medium access control protocol data unit header.

8. The terminal device of claim 1, wherein the feedback is transmitted in case of receiving from the network device, an indication indicating that the solution of the feedback for the downlink medium access control control element on the hybrid automatic repeat request process configured or indicated with hybrid automatic repeat request feedback disabled is supported.

9. The terminal device of claim 8, wherein the indication is received via at least one of the following: a system information block or a radio resource control signaling.

10. The terminal device of claim 1, wherein in a case where more than one downlink medium access control control elements on the hybrid automatic repeat request process configured or indicated with hybrid automatic repeat request feedback disabled are received before transmitting the feedback, the feedback for the downlink medium access control control elements is indicated in a bitmap transmitted to the network device.

11. The terminal device of claim 1, wherein in a case where more than one downlink medium access control control elements on the hybrid automatic repeat request process configured or indicated with hybrid automatic repeat request feedback disabled are received before transmitting the feedback, the feedback for the downlink medium access control control elements is indicated in a feedback bundling transmitted to the network device.

12. The terminal device of claim 1, wherein the hybrid automatic repeat request process is a single hybrid automatic repeat request process configured for the terminal device.

13-22. (canceled)

23. A method performed by a terminal device, comprising:
receiving from a network device, a downlink medium access control control element on a hybrid automatic repeat request process configured or indicated with hybrid automatic repeat request feedback disabled; and
transmitting to the network device, a feedback for the downlink medium access control control element.

24. The method of claim 23, wherein the feedback is transmitted according to a format indicated by the network device.

25-28. (canceled)

29. The method of claim 23, wherein the feedback is transmitted in an uplink medium access control control element or in a medium access control protocol data unit header.

30. The method of claim 23, wherein the feedback is transmitted in case of receiving from the network device, an indication indicating that the solution of the feedback for the downlink medium access control control element on the hybrid automatic repeat request process configured or indicated with hybrid automatic repeat request feedback disabled is supported.

31. The method of claim 30, wherein the indication is received via at least one of the following: a system information block or a radio resource control signaling.

32. The method of claim 23, wherein in a case where more than one downlink medium access control control elements on the hybrid automatic repeat request process configured or indicated with hybrid automatic repeat request feedback disabled are received before transmitting the feedback, the feedback for the downlink medium access control control elements is indicated in a bitmap transmitted to the network device.

33. The method of claim 23, wherein in a case where more than one downlink medium access control control elements on the hybrid automatic repeat request process configured or indicated with hybrid automatic repeat request feedback disabled are received before transmitting the feedback, the feedback for the downlink medium access control control elements is indicated in a feedback bundling transmitted to the network device.

34. The method of claim 23, wherein the hybrid automatic repeat request process is a single hybrid automatic repeat request process configured for the terminal device.

35-52. (canceled)
